(19) United States
(12) Patent Application Publication
(10) Pub. No.: US 2025/0373181 A1
(43) Pub. Date: Dec. 4, 2025

(54) SYSTEMS AND METHODS FOR PROVIDING MOTOR CONTROL FOR A CROSSING GATE MECHANISM

(71) Applicant: Siemens Mobility, Inc., New York, NY (US)

(72) Inventors: Leonard Wydotis, Marion, KY (US); Paul Young, Louisville, KY (US)

(73) Assignee: Siemens Mobility, Inc., New York, NY (US)

(21) Appl. No.: 18/678,302

(22) Filed: May 30, 2024

(51) Int. Cl. H02P 6/08; B61L 29/22; H02K 11/215; H02K 11/33; H02P 6/17; H02P 6/24

(52) U.S. Cl. CPC H02P 6/085; B61L 29/22; H02P 6/17; H02P 6/24; H02K 11/215; H02K 11/33; H02P 2205/07

(57) ABSTRACT

A crossing gate mechanism comprises an electric brushless direct current (BLDC) motor which has at least one internal sensing device that is used as a closed feedback loop to determine a position of the BLDC motor and accurately control a speed of the BLDC motor, a crossing gate arm operated via the BLDC motor and a digital control system configured to control operation of the BLDC motor, wherein the digital control system is configured to provide a motor control signal that results in a soft start motion and a soft stop motion of the crossing gate arm. The BLDC motor is controlled by a state-machine logic stored within a Field-Programmable Gate Array/a central processing unit such that the state-machine logic finely controls an acceleration and a deceleration of the BLDC motor that provides a relatively smooth operation of the crossing gate arm when it reaches both horizontal and vertical positions.

### BACKGROUND

### 1. Field

Aspects of the present disclosure generally relate to systems and methods for providing motor control for a crossing gate mechanism by a state-machine logic stored within a Field-Programmable Gate Array (FPGA)/a central processing unit (CPU) such that the state-machine logic controls an acceleration and a deceleration of an electric brushless direct current (BLDC) motor.

### 2. Description of the Related Art

Railroad crossing gates, which typically are raised by default and lowered when a train approaches and crosses an intersection of a road and railroad track (i.e., a crossing, also referred to as level crossing), may be provided for roadway and pedestrian safety. In some instances, there may be separate gates for the roadway and the pedestrian path. For public safety reasons, it is essential that these crossing gates operate correctly. Typically, railroad crossing gates utilize electrical and mechanical components to ensure that the gates perform their intended functions correctly. For example, gate arms are lowered using a motor located in a gate control mechanism. A crossing gate mechanism may be described as a gate control box housing multiple electric and electronic components for operating and controlling the signal control equipment and warning devices, such as the crossing gates.

Historical railroad crossing gates have a very coarse and abrupt analog motor control system that does not operate the motor and brake functions in a smooth and controlled manner, leading to significant wear of the drive train over the lifetime of the product.

The problem was never addressed with the design of historic gate mechanisms. They operate by a series of rotating cams that open and close electrical contacts. When the gate arm reaches the vertical position, the motor power contact quickly opens and the electric brake contact quickly closes, bringing the entire drive train to an immediate stop. Because the drive train has a great deal of inertia, especially with long gate arms up to 40 feet in length, the entire gate system oscillates when the gate reaches the vertical position. Customers refer to this as a “whipping action” of the gate arm. This oscillation is what causes considerable wear on the gate arm fasteners, the gate mechanism bearings, the mechanism's gears and the electric brake, which is energized to hold the gate vertical while it is still rotating at a rapid speed.

Prior designs utilize a mechanical cam and contact arrangement to operate an electronic MOSFET-based controller that “minimizes” the pumping action of the gate arm but does not eliminate it.

Therefore, a system and a method are then needed to provide motor control for a crossing gate mechanism.

### SUMMARY

Briefly described, aspects of the present disclosure relate to providing motor control for a crossing gate mechanism by a state-machine logic stored within a Field-Programmable Gate Array (FPGA)/a central processing unit (CPU) such that the state-machine logic controls an acceleration and a deceleration of an electric brushless direct current (BLDC) motor. This disclosure provides advanced motor control that results in a soft start and soft stop motion of the crossing gate arm, significantly improving the life expectancy of the device. The disclosure replaces the historical mechanical cam and contact arrangement with a microprocessor or FPGA-based control system. In addition, the disclosure utilized a brushless DC motor which has internal hall sensors that are used as a closed feedback loop to determine the position of the motor and accurately control the speed of the motor.

In accordance with one illustrative embodiment of the present disclosure, a crossing gate mechanism comprises an electric brushless direct current (BLDC) motor which has at least one internal sensing device that is used as a closed feedback loop to determine a position of the BLDC motor and accurately control a speed of the BLDC motor, a crossing gate arm operated via the BLDC motor and a digital control system configured to control operation of the BLDC motor, wherein the digital control system is configured to provide a motor control signal that results in a soft start motion and a soft stop motion of the crossing gate arm. The BLDC motor is controlled by a state-machine logic stored within a Field-Programmable Gate Array (FPGA)/a central processing unit (CPU) such that the state-machine logic finely controls an acceleration and a deceleration of the BLDC motor that provides a relatively smooth operation of the crossing gate arm when it reaches both horizontal and vertical positions. The BLDC motor is controlled so that a rotation of an electric brake comes to a stop before the electric brake is energized to keep the crossing gate arm in the vertical position.

In accordance with one illustrative embodiment of the present disclosure, a method is provided for motor control in a crossing gate mechanism. The method comprises providing an electric brushless direct current (BLDC) motor which has at least one internal sensing device that is used as a closed feedback loop to determine a position of the BLDC motor and accurately control a speed of the BLDC motor, providing the crossing gate arm operated via the BLDC motor and providing a digital control system configured to control operation of the BLDC motor, wherein the digital control system is configured to provide a motor control signal that results in a soft start motion and a soft stop motion of the crossing gate arm. The BLDC motor is controlled by a state-machine logic stored within a Field-Programmable Gate Array (FPGA)/a central processing unit (CPU) such that the state-machine logic finely controls an acceleration and a deceleration of the BLDC motor that provides a relatively smooth operation of the crossing gate arm when it reaches both horizontal and vertical positions. The BLDC motor is controlled so that a rotation of an electric brake comes to a stop before the electric brake is energized to keep the crossing gate arm in the vertical position.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 illustrates an example railroad crossing gate in accordance with an exemplary embodiment of the present disclosure.

FIG. 2 illustrates a perspective view of a crossing gate mechanism in accordance with an exemplary embodiment of the present disclosure.

FIG. 3 illustrates a block diagram of a crossing gate mechanism that includes an electric brushless direct current (BLDC) motor being controlled by a digital control system to provide a soft start/a soft stop motor control using a state-machine logic which controls an acceleration and a deceleration of the BLDC motor in accordance with an embodiment of the present disclosure.

FIG. 4 illustrates a block diagram of a Highway Crossing Gate Mechanism with an Advanced Motor Control in accordance with an embodiment of the present disclosure.

FIG. 5 illustrates a method of providing digital motor control for a crossing gate mechanism with an electric brushless direct current (BLDC) motor in accordance with an embodiment of the present disclosure.

### DETAILED DESCRIPTION

Various technologies pertain to systems and methods that provide motor control for a crossing gate mechanism. This disclosure eliminates the use of mechanical cams and electrical contacts to control the operation of the motor. The motor is controlled by a state-machine logic within the FPGA/processor. The logic finely controls the acceleration and deceleration of the motor that provides a very smooth operation of the gate arm when it reaches both the horizontal and vertical positions. The motor is controlled so that the rotation of the electric brake comes to a stop before the brake is energized to keep the gate arm in the vertical position. Not only does this eliminate the “whipping action” of the gate arm, but the electric brake will have significantly reduced wear because it is not energized while the motor is still rotating at a high speed as it did in previous mechanism designs. This disclosure uses a digital, microprocessor-or-FPGA-based motor control system and a brushless DC motor to provide the soft start/soft stop functionality. The prior art utilized mechanical cams and contacts to operate an electronic control system to control a permanent magnet motor, which has brushes in it. Prior art controls systems did not effectively provide soft start/soft stop motor control. The digital control system uses feedback loops on the speed and the position of the gate arm to implement the soft start/soft stop algorithm. Although the prior art designs claim to “minimize” the pumping or whipping action of the gate arm, they do not eliminate it. This disclosure eliminates the whipping action of the gate arm, greatly reduces the drive train component wear by slowly decelerating the arm's momentum, and greatly reduces wear of the electric brake friction surfaces because the brake is not rotating when it is energized. The use of a brushless DC motor with hall sensors allows for speed and position feedback that can be used by a microprocessor-or-FPGA-based control system to implement soft start/soft stop functionality. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

To facilitate an understanding of embodiments, principles, and features of the present disclosure, they are explained hereinafter with reference to implementation in illustrative embodiments. In particular, they are described in the context of providing motor control for a crossing gate mechanism. Embodiments of the present disclosure, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

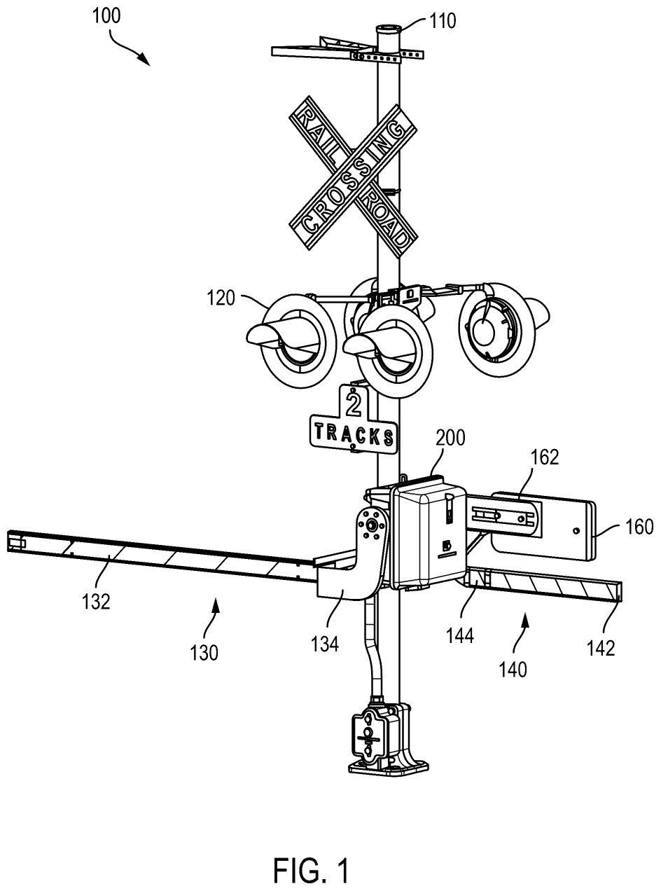

These and other embodiments of the system are provided for providing motor control for a crossing gate mechanism according to the present disclosure are described below with reference to FIG. 1 herein. The drawing is not necessarily drawn to scale.

A gate crossing mechanism protects motorists, pedestrians, and the like from oncoming trains by blocking level crossings or points at which public or private roads cross railway lines at the same level. As one example, a gate crossing mechanism can include an arm or “gate” that, using a motor, selectively lowers/raises depending upon whether a train or other vehicle is passing through the level crossing. For example, if a train is approaching a level crossing, a gate can be lowered to prevent traffic on the road or path from crossing the railway line. A level crossing can be equipped with multiple gate crossing mechanisms. For example, each side of the railway line can include a gate crossing mechanism. In larger intersections, each side of the railway line can include two (or more) gate crossing mechanisms. Gate crossing mechanisms can further include lights, sirens, bells, or other similar devices that can provide visual and/or aural warnings.

Conventional gate crossing mechanisms can be susceptible to failures, malfunctions, etc., which can reduce their reliability to control a level crossing safely. It is, therefore, desirable to improve efficiency and reliability of conventional gate crossing mechanisms.

Gate crossing mechanisms having the features and functionality described herein improve efficiency and address problems associated with conventional gate crossing mechanisms. For example, a gate crossing mechanism can include a brushless electric motor and digital control logic rather than a conventional brushed motor and mechanical cams. Motor brushes can experience uneven wear patterns, after which they must be replaced. This is both costly and time consuming for railways or those responsible for maintaining gate crossing mechanisms featuring brushed motors.

Additionally, brushless motors of the gate crossing mechanisms described herein support expanded fault detection such as overcurrent detection, which can be determined from measured three-phase motor currents. This active fault detection serves to increase the availability of the gate crossing mechanism. Finally, the brushless motors of the gate crossing mechanisms described herein support a configurable gate that can function as either an entrance or an exit gate, which can depend for example on field-programmable gate array (FPGA) firmware. This is a stark difference from the conventional gate crossing mechanisms, which can only function as an entrance gate unless an additional circuit card is attached.

Consistent with an embodiment of the present disclosure, FIG. 1 represents an example railroad crossing gate 100 in accordance with an exemplary embodiment of the present disclosure. FIG. 1 illustrates the railroad crossing gate 100 in a lowered or horizontal position. At many railroad crossings, at least one railroad crossing gate 100 may be placed on either side of the railroad track to restrict roadway traffic in both directions. At some crossings, pedestrian paths or sidewalks may run parallel to the roadway. To restrict road and sidewalk traffic, the illustrated railroad crossing gate 100 includes a separate roadway gate 130 and pedestrian gate 140. The roadway gate 130 and pedestrian gate 140 may be raised and lowered, i.e. operated, by gate control mechanism 200.

The example railroad crossing gate 100 also includes a pole 110 and signal lights 120. The gate control mechanism 200 is attached to the pole 110 and is used to raise and lower the roadway and pedestrian gates 130, 140. The illustrated railroad crossing gate 100 is often referred to as a combined crossing gate. When a train approaches the crossing, the railroad crossing gate 100 may provide a visual warning using the signal lights 120. The gate control mechanism 200 will lower the roadway gate 130 and the pedestrian gate 140 to respectively restrict traffic and pedestrians from crossing the track until the train has passed.

As shown in FIG. 1, the roadway gate 130 comprises a roadway gate support arm 134 that attaches a roadway gate arm 132 to the gate control mechanism 200. Similarly, the pedestrian gate 140 comprises a pedestrian gate support arm 144 connecting a pedestrian gate arm 142 to the gate control mechanism 200. When raised, the gates 130 and 140 are positioned so that they do not interfere with either roadway or pedestrian traffic. This position is often referred to as the vertical position. A counterweight 160 is connected to a counterweight support arm 162 connected to the gate control mechanism 200 to counterbalance the roadway gate arm 132. Although not shown, a long counterweight support arm could be provided in place of the short counterweight support arm 134.

Typically, the gates 130, 140 are lowered from the vertical position using an electric motor contained within the gate control mechanism 200. The electric motor drives gearing connected to shafts (not shown) connected to the roadway gate support arm 134 and pedestrian gate support arm 144. The support arms 134, 144 are usually driven part of the way down by the motor (e.g., somewhere between 70 and 45 degrees) and then gravity and momentum are allowed to bring the arms 132, 142 and the support arms 134, 144 to the horizontal position. In another example, the support arms 134, 144 are driven all the way down to the horizontal position by the electric motor of the gate control mechanism 200.

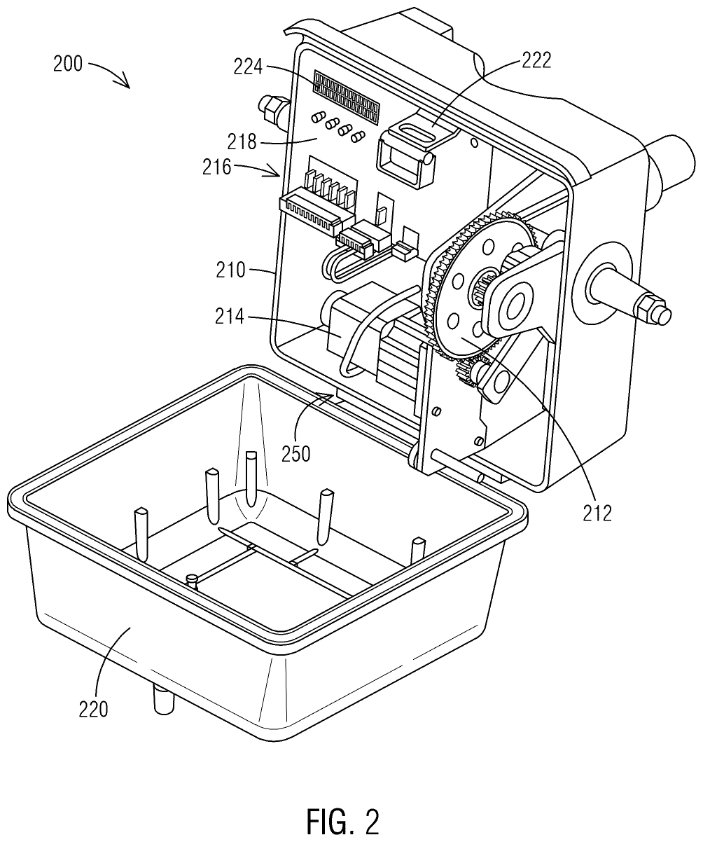

Referring to FIG. 2, it illustrates a perspective view of crossing gate mechanism 200 in accordance with an exemplary embodiment of the present disclosure. The crossing gate mechanism 200 comprises an enclosure 210 housing multiple electric and electronic components, such as for example gearing 212, electric motor 214 driving the gearing 212, and control unit 216. The control unit 216 comprises a printed circuit board (PCB) 218 with the necessary electronics for operating and controlling the gate mechanism 200 and associated crossing gate equipment, such as crossing gate arm(s), see for example FIG. 1. Further, the PCB 218 comprises for example display(s) and/or light emitting diodes (LEDs) 224, used for example to indicate or display status of the gate mechanism 200, such status including for example ‘Power on’, ‘Gate Control’, ‘Brake On’, ‘Health’ etc.

The enclosure 210 can be opened and closed via door or cover 220, for maintenance, repair, or other services. The cover 220 is moveable between a closed position and an open position, wherein FIG. 2 shows the cover 220 in the open position. The cover 220 is closed via hinge 250 and latch plate 222 in connection with a latch rod (not shown).

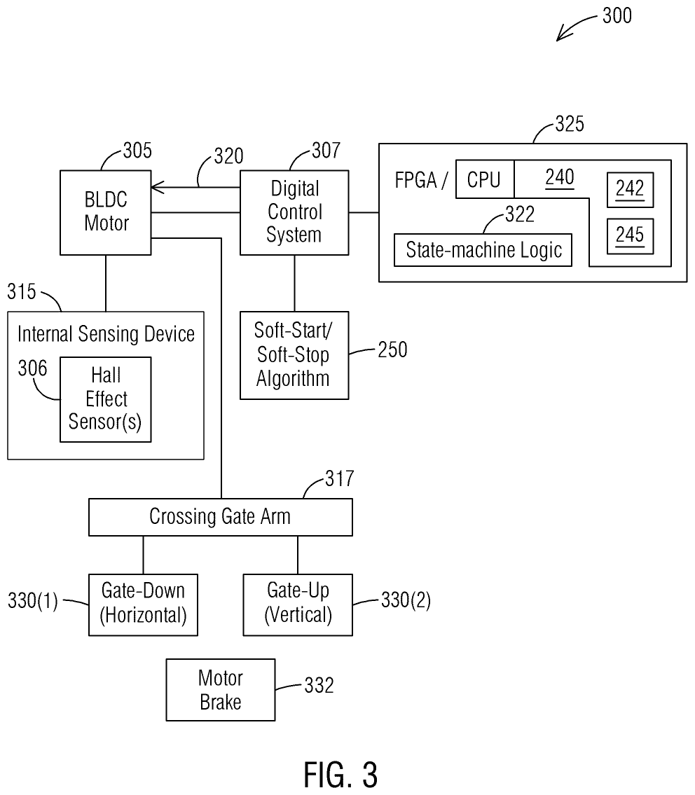

Turning now to FIG. 3, it illustrates a block diagram of a crossing gate mechanism 300 that includes an electric brushless direct current (BLDC) motor 305 being controlled by a digital control system 307 to provide soft start/soft stop motor control using a state-machine logic 322 which controls an acceleration and a deceleration of the BLDC motor 305 in accordance with an embodiment of the present disclosure.

In accordance with an exemplary embodiment of the present disclosure, the digital control system 307, is utilized for controlling the BLDC motor 305 inside the crossing gate mechanism 300 to raise or lower a crossing gate arm in response to gate control signals received from a grade crossing controller or constant warning time device arranged wayside adjacent to a railroad track, for example in a crossing bungalow. For example, with reference to FIG. 2, the digital control system 307 can be utilized within control unit 216 of gate mechanism 200 for controlling electric motor 214 to raise or lower gate arms 132, 142.

In an example, the digital control system 307, comprises (or is designed or implemented) as a field-programmable gate array (FPGA). In other examples, the digital control system 307 is designed or implemented in a real-time central processing unit (CPU), an application-specific integrated circuit (ASIC), a complex programmable logic device (CPLD) or a system-on-chip (SoC). In case of a SoC, the SoC comprises a CPU and an FPGA.

Specifically, the BLDC motor 305 is controlled and/or operated by the digital control system 307. The BLDC motor 305 is with at least one sensing device. The at least one sensing device comprises one or more Hall effect sensor(s) 306. For example, the electric BLDC motor 305 can be a 10-pole BLDC motor with three (3) Hall effect sensors 306. With reference to FIG. 3, Hall UVW are Hall effect sensor input signals received from the BLDC motor 305, specifically the Hall effect sensors installed in the BLDC motor 305.

The crossing gate mechanism 300 comprises the electric brushless direct current (BLDC) motor 305 which has at least one internal sensing device 315 that is used as a closed feedback loop to determine a position of the BLDC motor 305 and accurately control a speed of the BLDC motor 305. The internal sensing device 315 comprises one or more Hall effect sensor(s) 306.

The crossing gate mechanism 300 further comprises a crossing gate arm 317 operated via the BLDC motor 305. The crossing gate mechanism 300 further comprises the digital control system 307 configured to control operation of the BLDC motor 305. The digital control system 307 is configured to provide a motor control signal 320 that results in a soft start motion and a soft stop motion of the crossing gate arm 317.

The BLDC motor 305 is controlled by the state-machine logic 322 stored within a Field-Programmable Gate Array (FPGA)/a central processing unit (CPU) 325 such that the state-machine logic 322 finely controls an acceleration and a deceleration of the BLDC motor 305 that provides a relatively smooth operation of the crossing gate arm 317 when it reaches both horizontal and vertical positions 330(1-2). The BLDC motor 305 is controlled so that a rotation of an electric brake 332 comes to a stop before the electric brake 332 is energized to keep the crossing gate arm 317 in the vertical position 330(2).

The digital control system 307 may be implemented as the FPGA 325. Alternatively, the digital control system 307 may be implemented in a real-time central processing unit (RCPU), an application-specific integrated circuit (ASIC), a complex programmable logic device (CPLD) or a system-on-chip (SoC). The SoC comprises a CPU and an FPGA.

The CPU 325 comprises a memory 240 that stores a menu software 242 that provides an ascent time and a decent time and an angle calculation software 245 that provides a main shaft angle. The digital control system 307 uses feedback loops on a speed and a position of the crossing gate arm 317 to implement a soft start/soft stop algorithm 250 that effectively provides soft start/soft stop motor control.

The digital control system 307 eliminates a whipping action of the crossing gate arm 317 in which an entire gate system oscillates when the crossing gate arm 317 reaches the vertical position 330(2), greatly reducing a drive train component wear by slowly decelerating the arm's momentum during the operation of the crossing gate arm 317 when a train activates a railroad crossing. The digital control system 307 reduces wear of an electric brake's friction surfaces because the electric brake 332 is not rotating when it is energized.

The FPGA 325 stores a 3-phase motor controller firmware. The digital control system 307 is a digital, microprocessor-or-FPGA-based motor control system which with the electric brushless DC motor 305 provides soft start/soft stop functionality.

Firmware is indeed embedded and dedicated code, but the code is executed. FPGA code is written in a description language, then is interpreted, synthesized, and ultimately produces hardware. An FPGA has thousands of logic blocks, all of which can be programmed to create processes independent of one another, decreasing instances of bottlenecking as with microcontrollers. A primary difference between an FPGA and a microcontroller is that unlike a microcontroller, there is no fixed hardware structure within an FPGA. Rather, an FPGA has fixed logic cells, which, along with other interconnects, an engineer can program in parallel, using the HDL coding language. Precision or advanced motor control uses a real time response of an FPGA. The flexible nature of the interfaces is also useful.

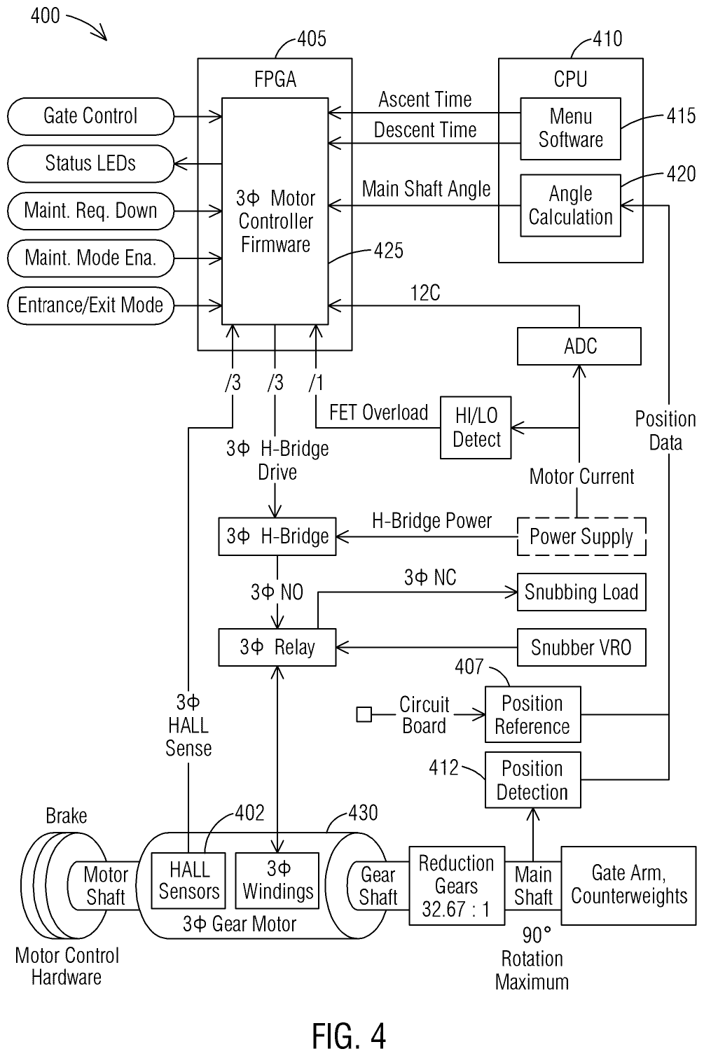

FIG. 4 illustrates a block diagram of a Highway Crossing Gate Mechanism 400 with an Advanced Motor Control in accordance with an embodiment of the present disclosure. Hall Sensors 402 provide Relative Position Data and Motor Speed to a FPGA 405. Position Reference 407 provides Absolute Position Data to a CPU 410, which is in turn written by the CPU 410 as a Main Shaft Angle to the FPGA 405. Position Detection 412 is a means by which the FPGA 405 and the CPU 410 determine the position of the Main Shaft by detecting a gate-down buffer. (also, this is referred to as homing or rehoming the gate-down buffer).

For the 2 components of the CPU 410:
a. 1st component of the CPU 410 is a Menu Software 415, which the customer uses to enter Ascent and Descent Times that are written by the CPU 415 to the FPGA 405.
b. 2nd component of the CPU 410 is Angle Calculation 420, which the CPU 410 performs by converting the X Y and Z axes data from the Position Reference to a Main Shaft Angle that is written to the FPGA 405.

A 3-phase Motor Controller Firmware 425 in the FPGA 405:
a. receives Relative Position Data and Motor Speed from the Hall Sensors 402,
b. receives Absolute Position Data (Main Shaft Angle) by working with the CPU 410,
c. receives desired Ascent and Descent Times from the CPU 410,
d. contains a PI control system to achieve a desired position,
e. contains a PI control system to run at a desired speed,
f. sends commutation command sequences in the form of 3-phase H-Bridge Drive signals to drive the 3-phase windings in a BLDC motor 430.

A state-machine logic within the FPGA 405 is responsible for:
a. configuring the logic to run as an entrance or exit gate based on the Entrance/Exit Mode selection,
b. responding to the Gate Control signal which commands the gate mechanism 400 raise or lower the gate arm,
c. driving the Status LEDs based on the health, condition and operation of the gate mechanism 400,
d. responding to health-related events such as FET Overload and I2C data from the ADC.

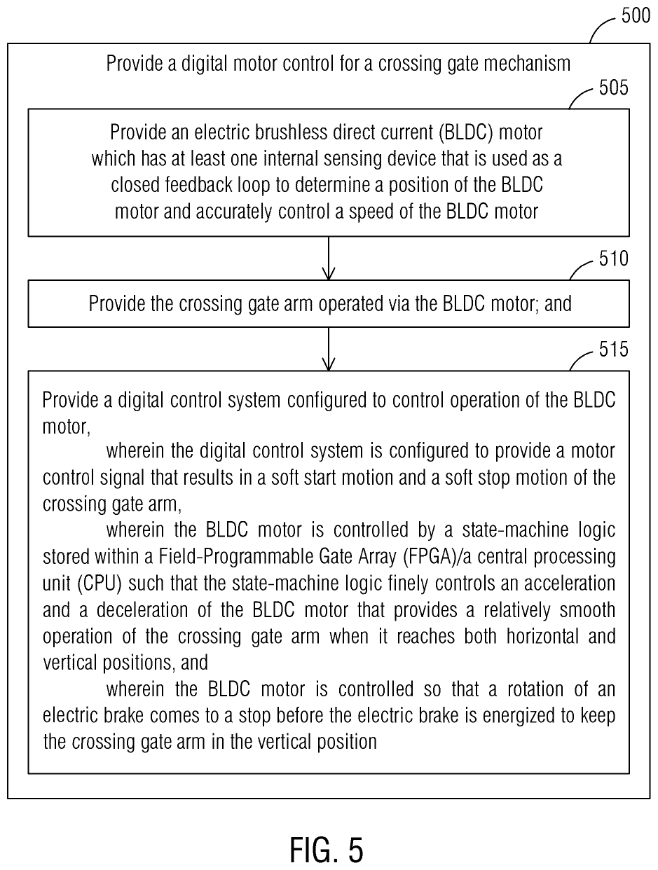

FIG. 5 illustrates a method 500 of providing the digital control system 307 for digital motor control within the crossing gate mechanism 300 with the electric brushless direct current (BLDC) motor 305 in accordance with an embodiment of the present disclosure. Reference is made to the elements and features described in FIGS. 1-4. It should be appreciated that some steps are not required to be performed in any particular order, and that some steps are optional.

The method 500 comprises a step 505 of providing an electric brushless direct current (BLDC) motor which has at least one internal sensing device that is used as a closed feedback loop to determine a position of the BLDC motor and accurately control a speed of the BLDC motor. The method 500 further comprises a step 510 of providing the crossing gate arm operated via the BLDC motor. The method 500 further comprises a step 515 of providing a digital control system configured to control operation of the BLDC motor, wherein the digital control system is configured to provide a motor control signal that results in a soft start motion and a soft stop motion of the crossing gate arm.

The BLDC motor is controlled by a state-machine logic stored within a Field-Programmable Gate Array (FPGA)/a central processing unit (CPU) such that the state-machine logic finely controls an acceleration and a deceleration of the BLDC motor that provides a relatively smooth operation of the crossing gate arm when it reaches both horizontal and vertical positions. The BLDC motor is controlled so that a rotation of an electric brake comes to a stop before the electric brake is energized to keep the crossing gate arm in the vertical position.

While a FPGA-based system is described here a range of one or more other systems are also contemplated by the present disclosure. For example, other systems based on a CPU may be implemented based on one or more features presented above without deviating from the spirit of the present disclosure.

The techniques described herein can be particularly useful for a BLDC motor. While particular embodiments are described in terms of the BLDC motor, the techniques described herein are not limited to such a motor type but other motor types may be used.

While embodiments of the present disclosure have been disclosed in exemplary forms, it will be apparent to those skilled in the art that many modifications, additions, and deletions can be made therein without departing from the spirit and scope of the disclosure and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the disclosure has been described with reference to specific embodiments. However, one of ordinary skill in the art appreciates that various modifications and changes can be made without departing from the scope of the disclosure. Accordingly, the specification and figures are to be regarded in an illustrative rather than a restrictive sense, and all such modifications are intended to be included within the scope of disclosure.

Although the disclosure has been described with respect to specific embodiments thereof, these embodiments are merely illustrative, and not restrictive of the disclosure. The description herein of illustrated embodiments of the disclosure is not intended to be exhaustive or to limit the disclosure to the precise forms disclosed herein (and in particular, the inclusion of any particular embodiment, feature or function is not intended to limit the scope of the disclosure to such embodiment, feature or function). Rather, the description is intended to describe illustrative embodiments, features and functions in order to provide a person of ordinary skill in the art context to understand the disclosure without limiting the disclosure to any particularly described embodiment, feature or function. While specific embodiments of, and examples for, the disclosure are described herein for illustrative purposes only, various equivalent modifications are possible within the spirit and scope of the disclosure, as those skilled in the relevant art will recognize and appreciate. As indicated, these modifications may be made to the disclosure in light of the foregoing description of illustrated embodiments of the disclosure and are to be included within the spirit and scope of the disclosure. Thus, while the disclosure has been described herein with reference to particular embodiments thereof, a latitude of modification, various changes and substitutions are intended in the foregoing disclosures, and it will be appreciated that in some instances some features of embodiments of the disclosure will be employed without a corresponding use of other features without departing from the scope and spirit of the disclosure as set forth. Therefore, many modifications may be made to adapt a particular situation or material to the essential scope and spirit of the disclosure.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the disclosure.

In the description herein, numerous specific details are provided, such as examples of components and/or methods, to provide a thorough understanding of embodiments of the disclosure. One skilled in the relevant art will recognize, however, that an embodiment may be able to be practiced without one or more of the specific details, or with other apparatus, systems, assemblies, methods, components, materials, parts. and/or the like. In other instances, well-known structures, components, systems, materials, or operations are not specifically shown or described in detail to avoid obscuring aspects of embodiments of the disclosure. While the disclosure may be illustrated by using a particular embodiment, this is not and does not limit the disclosure to any particular embodiment and a person of ordinary skill in the art will recognize that additional embodiments are readily understandable and are a part of this disclosure.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

1. A crossing gate mechanism, comprising:
an electric brushless direct current (BLDC) motor which has at least one internal sensing device that is used as a closed feedback loop to determine a position of the BLDC motor and accurately control a speed of the BLDC motor;
a crossing gate arm operated via the BLDC motor; and
a digital control system configured to control operation of the BLDC motor, wherein the digital control system is configured to provide a motor control signal that results in a soft start motion and a soft stop motion of the crossing gate arm,
wherein the BLDC motor is controlled by a state-machine logic stored within a Field-Programmable Gate Array (FPGA)/a central processing unit (CPU) such that the state-machine logic finely controls an acceleration and a deceleration of the BLDC motor that provides a relatively smooth operation of the crossing gate arm when it reaches both horizontal and vertical positions, and
wherein the BLDC motor is controlled so that a rotation of an electric brake comes to a stop before the electric brake is energized to keep the crossing gate arm in the vertical position.

2. The crossing gate mechanism of claim 1,
wherein the digital control system is implemented as the FPGA.

3. The crossing gate mechanism of claim 1,
wherein the digital control system is implemented in a real-time central processing unit (RCPU), an application-specific integrated circuit (ASIC), a complex programmable logic device (CPLD) or a system-on-chip (SoC).

4. The crossing gate mechanism of claim 3,
wherein the SoC comprises a CPU and an FPGA.

5. The crossing gate mechanism of claim 1,
wherein the at least one internal sensing device comprises one or more Hall effect sensor(s).

6. The crossing gate mechanism of claim 1,
wherein the CPU comprises a memory that stores a menu software that provides an ascent time and a decent time and an angle calculation software that provides a main shaft angle.

7. The crossing gate mechanism of claim 1,
wherein the digital control system uses feedback loops on a speed and a position of the crossing gate arm to implement a soft start/soft stop algorithm that effectively provides soft start/soft stop motor control.

8. The crossing gate mechanism of claim 7,
wherein the digital control system eliminates a whipping action of the crossing gate arm in which an entire gate system oscillates when the crossing gate arm reaches the vertical position, greatly reducing a drive train component wear by slowly decelerating the arm's momentum during the operation of the crossing gate arm when a train activates a railroad crossing.

9. The crossing gate mechanism of claim 8,
wherein the digital control system reduces wear of an electric brake's friction surfaces because an electric brake is not rotating when it is energized.

10. The crossing gate mechanism of claim 1,
wherein the FPGA stores a 3-phase motor controller firmware, and
wherein the digital control system is a digital, microprocessor-or-FPGA-based motor control system which with the electric brushless DC motor provides soft start/soft stop functionality.

11. A method of providing motor control for a crossing gate mechanism, wherein the method comprising:
providing an electric brushless direct current (BLDC) motor which has at least one internal sensing device that is used as a closed feedback loop to determine a position of the BLDC motor and accurately control a speed of the BLDC motor;
providing the crossing gate arm operated via the BLDC motor; and
providing a digital control system configured to control operation of the BLDC motor, wherein the digital control system is configured to provide a motor control signal that results in a soft start motion and a soft stop motion of the crossing gate arm,
wherein the BLDC motor is controlled by a state-machine logic stored within a Field-Programmable Gate Array (FPGA)/a central processing unit (CPU) such that the state-machine logic finely controls an acceleration and a deceleration of the BLDC motor that provides a relatively smooth operation of the crossing gate arm when it reaches both horizontal and vertical positions, and
wherein the BLDC motor is controlled so that a rotation of an electric brake comes to a stop before the electric brake is energized to keep the crossing gate arm in the vertical position.

12. The method of claim 11,
wherein the digital control system is implemented as the FPGA.

13. The method of claim 1,
wherein the digital control system is implemented in a real-time central processing unit (RCPU), an application-specific integrated circuit (ASIC), a complex programmable logic device (CPLD) or a system-on-chip (SoC).

14. The method of claim 13,
wherein the SoC comprises a CPU and an FPGA.

15. The method of claim 11,
wherein the at least one internal sensing device comprises one or more Hall effect sensor(s).

16. The method of claim 11,
wherein the CPU comprises a memory that stores a menu software that provides an ascent time and a decent time and an angle calculation software that provides a main shaft angle.

17. The method of claim 11,
wherein the digital control system uses feedback loops on a speed and a position of the crossing gate arm to implement a soft start/soft stop algorithm that effectively provides soft start/soft stop motor control.

18. The method of claim 17,
wherein the digital control system eliminates a whipping action of the crossing gate arm in which an entire gate system oscillates when the crossing gate arm reaches the vertical position, greatly reducing a drive train component wear by slowly decelerating the arm's momentum during the operation of the crossing gate arm when a train activates a railroad crossing.

19. The method of claim 18,
wherein the digital control system reduces wear of an electric brake's friction surfaces because an electric brake is not rotating when it is energized.

20. The method of claim 11,
wherein the FPGA stores a 3-phase motor controller firmware, and
wherein the digital control system is a digital, microprocessor-or-FPGA-based motor control system which with the electric brushless DC motor provides soft start/soft stop functionality.
